(19) United States
(12) Patent Application Publication
(10) Pub. No.: US 2022/0322116 A1
(43) Pub. Date: Oct. 6, 2022

(54) METHOD, APPARATUS AND SYSTEM FOR COMMUNICATING WI-FI SENSING MEASUREMENTS AND FEEDBACK

(71) Applicant: HUAWEI TECHNOLOGIES CO., LTD., SHENZHEN (CN)

(72) Inventors: Osama ABOUL-MAGD, Kanata (CA); Yan XIN, Kanata (CA); Jung Hoon SUH, Kanata (CA); Kwok Shum AU, Ottawa (CA)

(73) Assignee: HUAWEI TECHNOLOGIES CO., LTD., SHENZHEN (CN)

(21) Appl. No.: 17/700,679

(22) Filed: Mar. 22, 2022

Related U.S. Application Data
(60) Provisional application No. 63/171,315, filed on Apr. 6, 2021.

(51) Int. Cl. H04W 24/08

(52) U.S. Cl. CPC H04W 24/08

(57) ABSTRACT

A method comprises, by a communications device, receiving over a network interface a sensing request transmitted by a sensing initiator, the communications device measuring the received sensing request and determining a parameter of the received sensing request, and the communications device sending over the network interface an action frame to the sensing initiator. The action frame includes a category indicative that the action frame contains a sensing response. The sensing response includes the parameter in an information element of the action frame.

### CROSS-REFERENCE TO RELATED APPLICATIONS

This is the first application filed for the present invention.

### FIELD OF THE INVENTION

The present invention pertains to the field of wireless sensing and communications, and in particular to communicating information related to a wireless sensing signal, such as measurements related to channel state information (CSI).

### BACKGROUND

In communication systems it is often advantageous to determine characteristics of the communications channel between a transmitter and receiver. Channel state information (CSI) refers to channel properties and parameters of the communication link. CSI describes how a signal propagates from the transmitter to the receiver and represents the combined effect of several factors that may include scattering, fading, interference, and power attenuation. Channel estimation refers to techniques that may be used to determine CSI. Knowing the CSI for a communications channel makes it possible to adapt transmissions to current channel conditions, which may be used to optimize communications.

CSI is typically estimated at a receiver wireless communication device, with the results being digitized and fed back to the transmitter. In other systems, such as in some Time Division Duplex (TDD) systems, reverse-link estimation is possible. Transmissions between a first device and a second device may have different CSI depending on the direction of transmission.

Many publications describe the use of Wi-Fi radiofrequency (RF) signals for identification and recognition of human activities, such as walking, sitting, standing, gait, etc., and other applications. One sensing method relies on the use of the Wi-Fi CSI capabilities to monitor changes to the CSI sequence (including amplitude, phase, and other characteristics). Wi-Fi CSI was first introduced in 802.11n in the context of multiple-input and multiple-output (MIMO) antennas, transmitters, and receivers. When an object, such as a human body, is located between a Wi-Fi transmitter and a Wi-Fi receiver, that object affects the communication channel between the transmitter and receiver. The effect can vary due to motion of the object, for example due to gestures.

CSI represents how an electric signal propagates from the transmitter to the receiver and the combined effect of scattering, fading, and power decay with distance of the signal. The CSI training sequence is a known sequence designed to measure the channel effect between the transmitter and the receiver. Changes to the CSI sequence can then be processed to identify certain events such as human gestures, human identity, etc. CSI represents the wireless signals propagation characteristics for the link from the transmitter to the receiver at certain carrier frequencies. CSI measurements are affected by how wireless signals propagate through and around surrounding objects and humans in time, frequency, and spatial domains and can be used for various wireless sensing applications. For example, amplitude variations in CSI in the time domain can show different patterns for different humans, activities, gestures, etc. Phase shifts in CSI in the spatial and frequency domains, i.e., transmit/receive antennas and carrier frequencies, are related to signal transmission delay and direction which can be used for human localization and tracking. Phase shifts in CSI in the time domain may demonstrate different dominant frequency components which can be used to estimate breathing rate.

Wi-Fi and other communications standards rely on consistent implementations between devices from the same manufacturer and between devices from different manufacturers in order to ensure interoperability of devices and networks.

Presently, there exists no standardized method for a receiver to feed back CSI information to a transmitter. This leads to difficulties in the development and implementation of applications that rely on CSI measurements. Therefore, there exists a need for a standardized method of communicating CSI, compatible with present Wi-Fi standards, that is not yet addressed in the art.

This background information is provided to reveal information believed by the applicant to be of possible relevance to the present invention. No admission is necessarily intended, nor should be construed, that any of the preceding information constitutes prior art against the present invention.

### BRIEF SUMMARY

An object of embodiments of the present invention is to provide a method, apparatus, system and computer-readable storage medium that involves communicating information related to wireless sensing signaling, such as channel state information (CSI), between communication devices. For example, the communication may be from a responder communications device to the communications device that initiated a measurement operation. Embodiments send feedback using frame formats that exist in existing Wi-Fi standards in a manner that facilitates backwards compatibility and interoperability between different communications devices.

In accordance with embodiments of the present invention, there is provided a method performed by a communications device. The communications device can receive, over a network interface, a sensing request transmitted by a sensing initiator. The communications device can then measure the received sensing request and determines a parameter of the received sensing request. The communications device sends over the network interface, an action frame to the sensing initiator. The action frame belongs to a category indicative that the action frame contains a sensing response. The sensing response includes the parameter in an information element of the action frame.

A potential technical benefit of the above is that CSI information is communicated using an existing Wi-Fi standard frame format.

In further embodiments, the parameter includes one or more of: an amplitude difference between the received sensing request and the sensing request transmitted by the sensing initiator; a phase difference between the received sensing request and the sensing request transmitted by the sensing initiator; an amplitude of the received sensing request; a phase of the received sensing request; an angle of arrival of the sensing request; an angle of departure of the sensing request; and a time of flight of the sensing request.

A potential technical benefit of the above is that the types of information includes in the CSI measurements can be customized.

In further embodiments, a type of the parameter is specified in the information element.

In further embodiments, the information element includes one or more of: a Tx (transmit) port antenna index; an Rx (receive) antenna port index; and a subcarrier index.

A potential technical benefit of the above is that CSI measurements can be communicated for a given combination of Tx antenna, Rx antenna, and subcarrier, as used in MIMO Wi-Fi communications systems.

In further embodiments, the sensing response includes a plurality of parameters of the received sensing request where the plurality of parameters including the parameter.

A potential technical benefit of the above is that multiple CSI parameters can be communicated in a single action frame.

In accordance with embodiments of the present invention, there is provided a communications device including a processor coupled to a network interface and a (e.g. non-transitory) computer readable storage medium. The communications device receives, over a network interface, a sensing request transmitted by a sensing initiator. The communications device also measures the received sensing request and determine a parameter of the received sensing request. The above actions may be performed due to executing instructions stored in the storage medium. The storage medium stores instructions which, when executed by the processor, cause the communications device to cause the communications device to send over the network interface, an action frame to the sensing initiator. The action frame includes a category indicative that the action frame contains a sensing response. The sensing response includes the parameter in an information element of the action frame.

In accordance with embodiments of the present invention, there is provided a computer-readable storage medium having stored thereon a computer program which, when executed by a communications device, causes the communications device to perform a method. The method includes forming an action frame including: an action frame header portion; a sensing measurement action; and a sensing measurement information element. The sensing measurement information element includes an element ID, a measurement type, and a parameter of a received sensing request measured by the communications device. The method also includes sending the action frame to a sensing initiator of the sensing request.

This provides the technical benefit of an action frame format that may be used in a multi-vendor environment to communicate CSI data between a sensing responder and a sensing initiator.

In further embodiments, the information element further includes a plurality of parameters of the received sensing request where the plurality of parameters including the parameter.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

FIG. 1 illustrates communications between a sensing initiator and sensing responders, in accordance with an embodiment.

FIG. 2 illustrates a Wi-Fi 802.11 sensing action frame format, according to an embodiment.

FIG. 3 illustrates indicators of sensing measurement actions to be included in a sensing action frame, according to an embodiment.

FIG. 4 illustrates a sensing measurements information element, according to an embodiment.

FIG. 5 illustrates a sensing measurements information element including multiple identifiers, according to an embodiment.

FIG. 6 illustrates a communications device that may implement or include embodiments.

It will be noted that throughout the appended drawings, like features are identified by like reference numerals.

### DETAILED DESCRIPTION

An object of embodiments of the present invention is to provide a method, apparatus, and computer-readable storage medium for communicating feedback information related to wireless sensing signaling. The feedback information can be channel state information (CSI), and the invention is described using CSI as the feedback information by way of non-limiting example. The feedback information can be communicated from a responder communication device to the communication device that initiated the measurement. The feedback information can be communicated using adaptations of frame formats which are defined in the Wi-Fi standards. This facilitates backwards compatibility and interoperability between different communications devices.

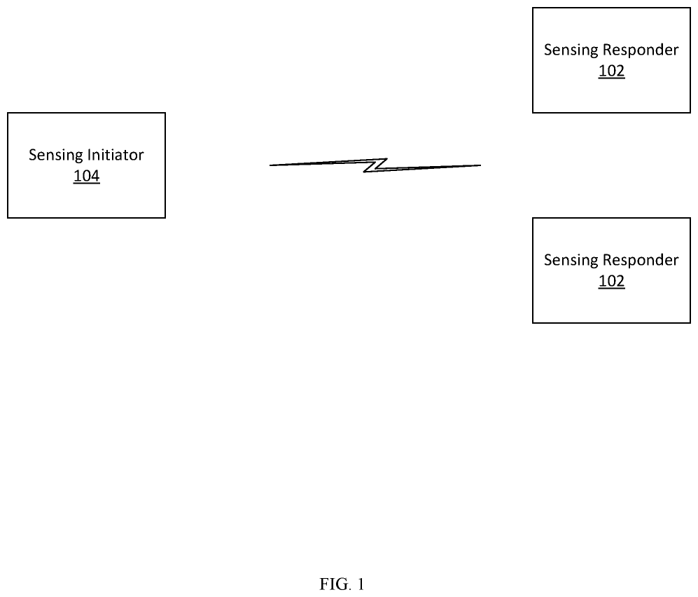

FIG. 1 illustrates communications between a sensing initiator 104 and sensing responders 102, in accordance with an embodiment. A sensing initiator 104, which may be a wireless access point (AP), is in communication with one or more sensing responder(s) 102. In other embodiments, the sensing initiator may also reside in a non-AP station (STA). Sensing initiator 104 initiates the sensing process and determines which devices to send sensing sequences to in order to receive a sensing response. Sensing responder 102 may receive a sensing request from sensing initiator 104, including a sensing sequence, or reference sequence, and in response, return feedback sensing measurements back to the sensing initiator. Sensing responder 102 may also send a sensing sequence to the sensing initiator in order to obtain bi-directions CSI.

The communication environment between the sensing initiator 104 and the sensing responders 102 can include one or more objects to be sensed. By way of example, the object to be sensed can be a human body which, by way of further example, can be performing gestures to be sensed. The presence, location, orientation, and configuration (e.g. pose) of the object affects the communication environment. For example, the transfer function of a communication channel between sensing initiator and sensing responders can be affected. Such effects on the transfer function can in turn affect the sensing sequence being transmitted. For example, the amplitudes and phases of one or more signals in the sensing sequence can be affected. By detecting changes to the transfer function (which involves feeding back information from the sensing responder to the sensing initiator), information about the object can be obtained. By using multiple subcarriers, multiple antennas, and multiple signals over time, greater information about the object can be obtained.

Embodiments of the present invention provide for a set of sensing measurements parameters and a frame format for sensing measurements feedback, including associated information elements (IE).

Most wireless communication systems utilize a digital modulation system with multiple carriers such as quadrature amplitude modulation (QAM), phase shift keying (PSK), quadrature phase shift keying (QPSK), etc. 5G cellular standards utilize 16 QAM, 64 QAM, and 256 QAM modulation. Upcoming Wi-Fi 6 (IEEE 802.11ax) systems may utilize 1024 QAM modulation. Using these modulation schemes, the key characteristics of each carrier state may be expressed using a phase, θ, and an amplitude, α. Many wireless standards also provide the ability to utilize MIMO technology with multiple transmit and receive antennas. In embodiments, each unique combination of Tx antenna, Rx antenna, and carrier may be treated as a separate sub-channel with its own CSI characteristics. Therefore, for example, when characterizing the communications channel between two communications devices using two transmit and two receive antennas implementing MIMO and using 64 subcarriers, there are 2×2×64=256 antenna and subcarrier CSI measurements to be obtained.

Given a communication channel with k transmitter antennas, l receiver antennas, and m subcarriers, for each transmit-receive antenna pair and subcarrier, the CSI can be expressed using a value Cₖₗₘ. This value can be represented by a number of different parameters. In embodiments, two parameters indicative of the CSI are the amplitude, α, and phase, θ, of the received signal on each subcarrier. Accordingly, in various embodiments the CSI can be expressed as a complex number:

Cₖₗₘ=αₖₗₘe^{iθ}^{ₖₗₘ}

When measuring CSI, the phase and amplitude of the signal transmitted on each subcarrier is known as part of the sensing sequence. At the receiver, the received signal is measured and processed (e.g. analyzed) and may be reported in several different ways. The effect on the transmitted signal caused by the channel, a difference, Δ, in the received phase and amplitude with respect to the transmitted phase and amplitude may be calculated at the receiver and fed back to the transmitter. Therefore, we can write:

Cₖₗₘ+ΔCₖₗₘ=(αₖₗₘ+Δαₖₗₘ)e^{i(θ}^{ₖₗₘ}^{+θ}^{ₖₗₘ}⁾,

In some embodiments, the responder 102 may measure the received signal, determine Δαₖₗₘ and Δθₖₗₘ, and feed back the values of Δαₖₗₘ and Δθₖₗₘ to the initiator 104. As the Δ amplitude and phase values will typically be smaller than the original amplitude and phase values, they may potentially be encoded with fewer bits and may be fed back to the transmitter using less bandwidth. Note that this requires the responder 102 know the phase and amplitude of the transmitted signals, also known as the sensing sequence, in advance.

Alternatively, in embodiments the whole received value of phase and amplitude may be fed back to the transmitter and the effect of the channel may be calculated by the transmitter. That is, αₖₗₘ+Δαₖₗₘ and θₖₗₘ+Δθₖₗₘ may be sent from the responder 102 to the initiator 104, and the process of extracting Δαₖₗₘ and Δθₖₗₘ may be left to the initiator 104.

In embodiments, other parameters such as Angle of Arrival (AOA) and Angle of Departure (AOD) can be estimated using spatial diversity, the phase difference between received signals on multiple antennas via CSI measurement for the location (direction). Both AOA and AOD measurements may return azimuth, elevation, and accuracy measurements of the azimuth and elevation.

In embodiments, Time of Flight (TOF) may also be used to estimate the position of an object by measuring its distance through considering the phase shift between subcarriers as a function of TOF to reformulate the steering matrix used in MIMO communications. TOF measurements may be reported as a real number representing the time of reception or a propagation delay measured by the receiver. When measuring and reporting AOD, AOA, and TOF measurements, both antennas and subcarriers can be treated as sensors. In some embodiments, TOF measurements require time synchronization between the sensing initiator 104 and sensing responder 102.

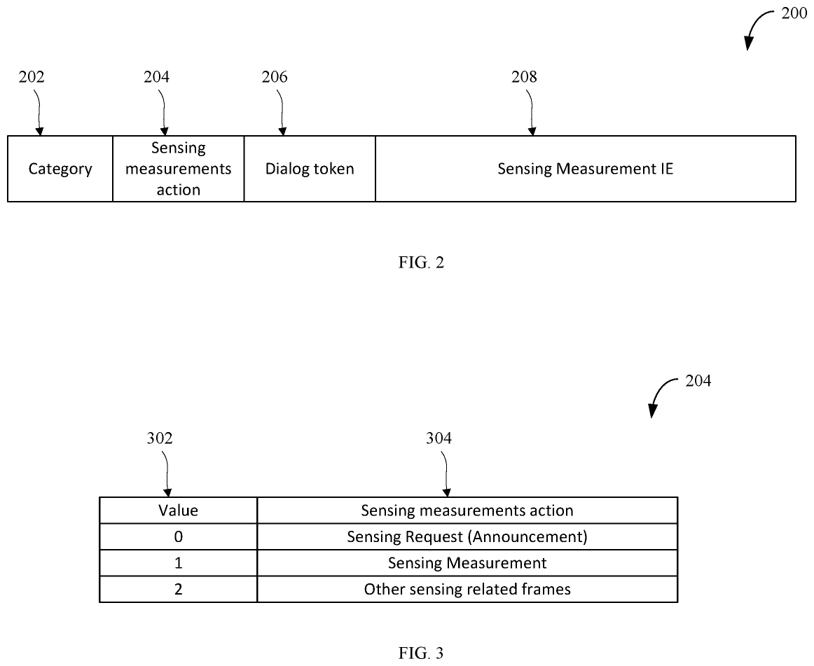

FIG. 2 illustrates a Wi-Fi IEEE 802.11 sensing action frame 200, according to an embodiment. The 802.11 standard specifies action frames to provide information and direction on actions to be performed by wireless communications devices. These include actions related to spectrum management, Quality of Service (QoS), etc. Embodiments utilize action frames to feed back changes in the CSI amplitude, phase, and other parameters back to the initiator. The first field of the action frame 200 is the Category field 202 (or subfield) used to identify the type of the action frame. Embodiments utilize a “sensing” category to indicate that the action frame pertains to a Wi-Fi CSI sensing process. Embodiments of the present invention may provide for a newly defined “sensing” category of action frame. The action frame is standardized under IEEE 802.11. Sensing measurements action field 204 is used to indicate individual actions related to the sensing process. Dialog token field 206 may be used for bookkeeping purposes between a transmitter and a receiver. Sensing measurement information element (IE) 208 is used to carry sensing information between sensing initiator 104 and sensing responder 102, including CSI information from sensing responder 102 back to sensing initiator 104. One, two or more sensing measurement IEs may be included in a sensing action frame.

FIG. 3 illustrates three possible sensing measurement actions 304 that may be indicated using values 302. The presence of value 302 in sensing measurements action field 204 indicates to the receiving device the action to be taken. The value 302 itself can indicate the content of the frame and processing of the frame can be performed correspondingly. A sensing request may be used by either sensing initiator 104, sensing responder 102, or another entity to initiate a sensing request to perform CSI measurements over a communications channel. Sensing measurement may be used by a sensing responder 102 to feed back CSI measurements to sensing initiator 104. Other sensing actions may also be supported. The illustrated correspondence between particular values and particular sensing measurement actions is provided by way of example only, and can be changed to a different correspondence.

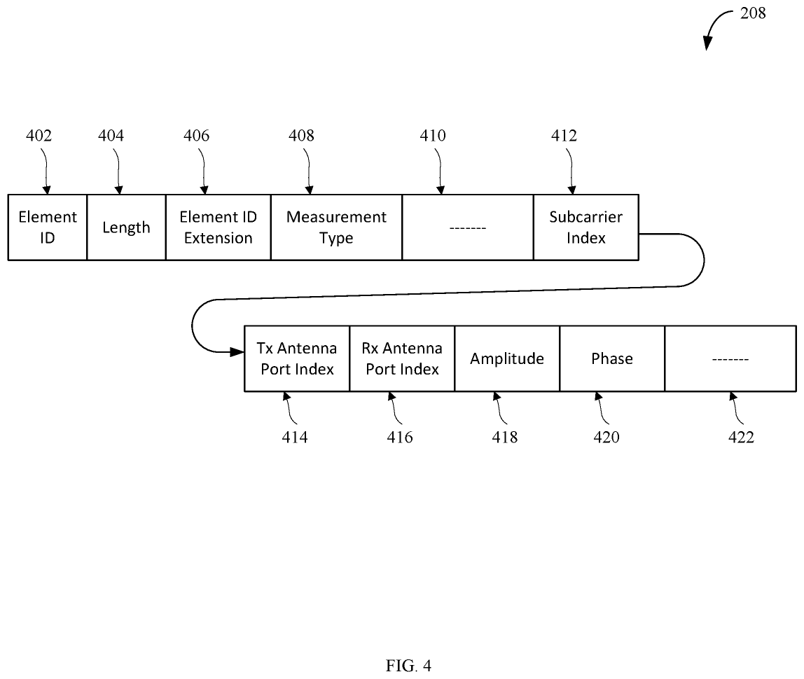

FIG. 4 illustrates a sensing measurements information element, which is generated according to an embodiment of the present invention. Element ID field 402 holds an ID number. Length field 404 indicates the length of the rest of information element other than element ID 402 and length field 404. Element ID extension field 406 may be used to expand the number of bits for element ID 402. Measurement type field 408 may be used to specify the format and contents of the CSI information fed back from sensing responder 102 to sensing initiator 104. Embodiments may use measurement types such as raw CSI, differential CSI, CSI amplitude values, differential amplitude values, CSI phase values, differential phase values, and other.

When using the raw CSI measurement type, the amplitude, αₖₗₘ+Δαₖₗₘ, and phase, θₖₗₘ+Δθₖₗₘ, values are transmitted from the sensing responder 102 back to the sensing initiator 104. In other words, for the raw CSI measurement type, the actual observed amplitude and phase information (also referred to as raw or full values) are reported in the sensing measurement information element.

When using the differential CSI measurement type, the amplitude difference, Δαₖₗₘ, and phase difference, Δθₖₗₘ, are transmitted from the sensing responder 102 back to the sensing initiator 104. In other words, for the differential CSI measurement type, an indication of the observed difference between transmitted and received amplitude and phase (also referred to as a differential value) is reported in the sensing measurement information element.

The CSI amplitude values measurement type includes the amplitude, αₖₗₘ+Δαₖₗₘ, values being transmitted from the sensing responder 102 back to the sensing initiator 104 without phase information being transmitted back to the sensing initiator 104.

The differential amplitude values measurement type includes the amplitude difference, Δαₖₗₘ, being transmitted from the sensing responder 102 back to the sensing initiator 104, without αₖₗₘ or phase information being transmitted back to the sensing initiator 104.

The CSI phase values measurement type includes phase, θₖₗₘ+Δθₖₗₘ, values being transmitted from the sensing responder 102 back to the sensing initiator 104 without amplitude information being transmitted back to the sensing initiator 104.

The differential phase values measurement type includes phase difference, Δθₖₗₘ, values being transmitted from the sensing responder 102 back to the sensing initiator 104 without phase, θₖₗₘ, and amplitude information being transmitted back to the sensing initiator 104.

In some embodiments, both amplitude and phase information can be included in the frame. The amplitude and phase information can both be represented using differential values, or the amplitude and phase information can both be represented as full values, or one of the amplitude and phase information can be represented using a differential value while the other is represented as a full value. In some embodiments, amplitude information can be included (as a differential or full value) in the frame and phase information can be excluded. In some embodiments, phase information can be included (as a differential or full value) in the frame and amplitude information can be excluded. The type of information included, its representation, or both, can be selected based on sensing application requirements and limitations, for example.

In embodiment, the measurement type field 408 utilizes type identifiers corresponding to different measurement types. For example, measurement type 1 may indicate raw (full) CSI, measurement type 2 may indicate differential CSI, measurement type 3 may indicate location-related parameters such as AOA, AOD, TOF, . . . , etc.

Each CSI measurement is specific to a combination of transmitter antenna, receiver antenna, and subcarrier. Information element 208 may include fields “subcarrier index” 412, “Tx antenna port index” 414, and “Rx antenna port index” 416 to indicate these values to the sensing initiator 104.

When feeding back CSI measurement data, specific fields may be provided for amplitude data 418, phase data 420, as well as other CSI parameters such as AOA, AOD, and TOF.

Fields 410 and 422 of information element 208 may optionally be used to carry further information within action frame 200.

The measurement type identifier 408 indicates the inclusion of the measurement results in a form of an identified measurement type. There may be one of more measurement types depending on the sensing applications.

In other embodiments, for each transmitter/receiver pair, CSI measurements may be transmitted in separate action frames. In this case sensing action frame values are identified accordingly.

In embodiments, feedback may depend on how significant the changes are. Minor changes, below a predetermined threshold may be ignored. In this case no feedback for this particular subcarrier is transmitted. This helps to reduce the amount of data to be returned from sensing responder 102 to sensing initiator 104. In other words, a device may be configured to refrain from sending feedback, such as a sensing action frame, when the device determines that changes to the channel over a certain time interval are below a threshold, the device may refrain from transmitting a sensing action frame. When the device determines that changes to the channel over a certain time interval are above a threshold, the device may transmit a sensing action frame.

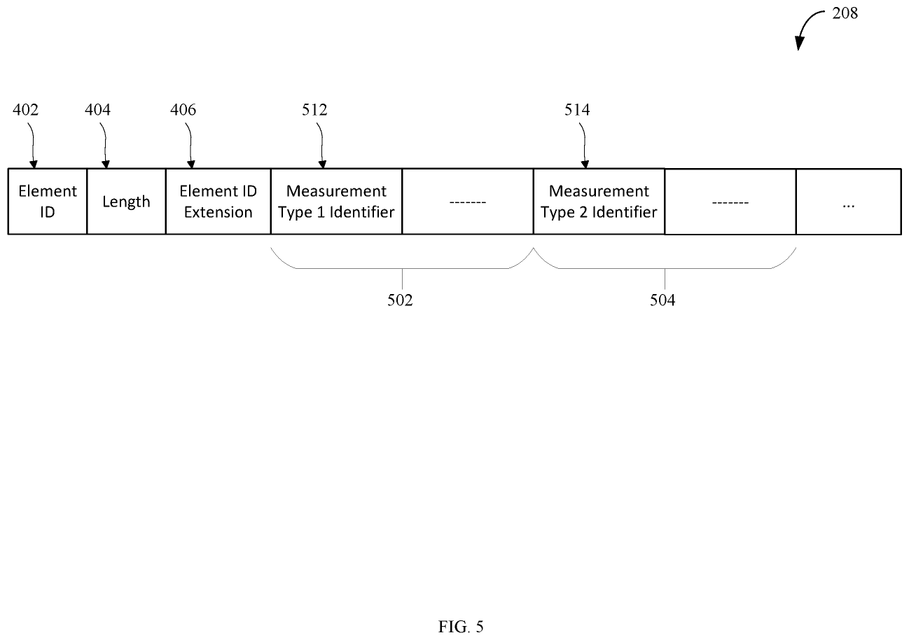

FIG. 5 illustrates a sensing measurements information element 208 including multiple measurement type identifiers, according to an embodiment. Element ID 402, length 404, and element ID extension 406 fields are the same as the information element illustrated in FIG. 4. At least two measurement type identifiers, 512 and 514 are illustrated though an arbitrary number of measurement type identifiers may be used. Measurement type 1 identifier is associated with information element 502 while measurement type 2 identifier is associated with information element 504. Each measurement type identifier indicates the inclusion of the measurement results in a form of an identified measurement type. The contents and format of information elements 502 and 504 are as illustrated in fields 410 through 422 of FIG. 4. Using the information element format of FIG. 5, measurement type 1 and measurement type 2 may have different formats. For example, measurement type 1 may indicate that the measurement includes raw (full) CSI data. Measurement type 2 may indicate that the measurement includes differential CSI data. Measurement type 3 (if used) may indicate that the measurement includes location-related parameters such as AOA, AOD, and TOF. Each measurement can include data such as raw CSI data, differential CSI data, raw or differential carrier amplitude data, raw or differential carrier phase data, signal angle of arrival data, signal angle of departure data, signal time of flight data, or other data. The measurement type identifier can indicate which type of data is being indicated, and the field following the measurement type identifier can include the data itself.

In view of the above, embodiments of the present invention provide for a method, apparatus and system for communicating wireless sensing information between wireless devices. The method can include generating, transmitting, or both generating and transmitting a message which contains the wireless sensing information. The message can be or include an IEEE 802.11 action frame. The apparatus can be an apparatus configured to generate, transmit, or both generate and transmit the message. The system can include multiple apparatuses, including one or more which are configured to generate, transmit or both generate and transmit messages containing wireless sensing information, one or more which are configured to receive, process or both receive and process the messages, or a combination thereof. The wireless sensing information can be information which is used for sensing physical objects in a wireless environment, based on the objects' effect on wireless signals propagating through the wireless environment. The wireless sensing information can include information indicative of subcarrier signals, such as subcarrier amplitude, subcarrier phase, angle of arrival or angle of departure information, time of arrival, time of departure, or time of flight information, or a combination thereof. The wireless sensing information can be provided for one, two or more subcarriers. The wireless sensing information can be provided for signals transmitted from one, two or more transmit antennas, for example belonging to an antenna array. The wireless sensing information can be provided for signals received by one, two or more receive antennas, for example belonging to an antenna array.

The wireless sensing information can be provided in a message configured as an IEEE 802.11 frame, in particular an action frame, as defined in the IEEE 802.11 standard. The action frame can be specified to have an appropriate category, for example to designate the action frame as a frame which carries wireless sensing information (e.g. called a “sensing action frame.”) The frame can include category, action identifier and dialog tokens. As described above, the frame can include one, two or more information elements. The frame, or more particularly some or all information elements thereof, can include element ID, length, and element ID extension fields, which are standardized fields of IEEE 802.11 action frames. Each information element can include information relating to one, two or more measurement values.

In various embodiments, information relating to a measurement value, as included in an information element, can include an indication of the type, format, or both type and format of the measurement being made, and an indication of the measurement itself. In some embodiments, when the measurement pertains to a particular subcarrier, the information relating to the measurement value includes an indication of that subcarrier, for example as indicated using a subcarrier index.

In some embodiments, when the measurement pertains to a particular transmit antenna, receive antenna, or transmit and receive antenna taken pairwise, then the information relating to the measurement value can include an indication of that antenna or pair of antennas. Rather than individual antennas, the information can include an indication of an antenna sub-array or pair of sub-arrays.

In some embodiments, the indication of the measurement can include an indication of subcarrier amplitude, subcarrier phase, or a combination thereof. The indication of subcarrier amplitude or subcarrier phase can be presented in a raw or full format, or in a differential format. In some embodiments, the indication of the measurement can include an indication of an angle (e.g. AOA or AOD), or an indication of an amount of time (e.g. a TOF).

The arrangement and ordering of fields in an information element can be varied, provided that the information can be reliably received and processed. In some embodiments, the arrangement and ordering of fields is configured so that information can be reliably received by a variety of devices and so that backward compatibility can be achieved.

Accordingly, embodiments of the present invention provide for an electronic device which is configured to communicate wireless sensing measurement information in a format which is compatible with IEEE 802.11 standards.

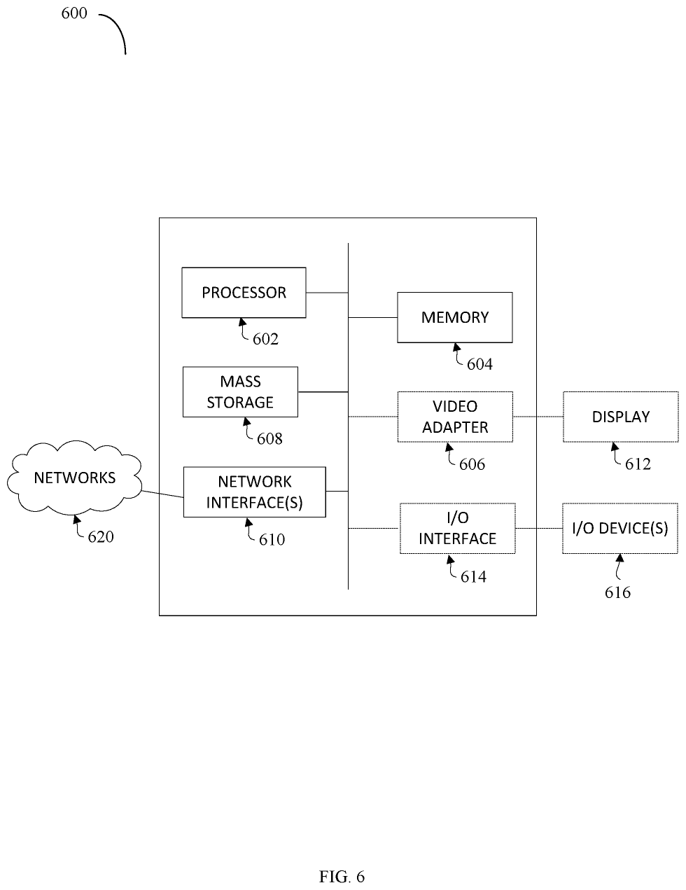

FIG. 6 is a schematic diagram of a communications device 600 that may perform any or all of operations of the above methods and features explicitly or implicitly described herein, according to different embodiments of the present invention. For example, a user equipment or access point equipped with network functions may utilize or include communications device 600.

As shown, the device includes a processor 602, such as a Central Processing Unit (CPU) or specialized processors such as a Graphics Processing Unit (GPU) or other such processor unit, memory 604, non-transitory mass storage 608, and network interface 610, all of which are communicatively coupled via bi-directional bus. Network interface may connect to a number of wireless or wired network 620, such as a cellular network or a Wi-Fi wireless network as describes herein.

According to certain embodiments, any or all of the depicted elements may be utilized, or only a subset of the elements. Further, the device 600 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 604 may include any type of non-transitory memory such as static random access memory (SRAM), dynamic random access memory (DRAM), synchronous DRAM (SDRAM), read-only memory (ROM), any combination of such, or the like. The mass storage element 608 may include any type of non-transitory storage device, such as a solid state drive, hard disk drive, a magnetic disk drive, an optical disk drive, USB drive, or any computer program product configured to store data and machine executable program code. According to certain embodiments, the memory 604 or mass storage 608 may have recorded thereon statements and instructions executable by the processor 602 for performing any of the aforementioned method operations described above.

Optionally, I/O interface 614, such as USB ports may provide access to internal or external user interface devices, such as keyboard or mouse, or to external modules such as sensors. Optional video adapter 606 may provide access to internal or external displays 612 for displaying user interface elements and for accepting user input on a resistive or capacitive touch screen interface.

Unless defined otherwise, all technical and scientific terms used herein have the same meaning as commonly understood by one of ordinary skill in the art to which this invention belongs.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising, by a communications device:
receiving over a network interface, a sensing request transmitted by a sensing initiator;
measuring the received sensing request and determining a parameter of the received sensing request;
sending over the network interface, an action frame to the sensing initiator, the action frame including a category indicative that the action frame contains a sensing response, the sensing response including the parameter in an information element of the action frame.

2. The method of claim 1 wherein the parameter is indicative of one of:
an amplitude difference between the received sensing request and the sensing request transmitted by the sensing initiator;
a phase difference between the received sensing request and the sensing request transmitted by the sensing initiator;
an amplitude of the received sensing request;
a phase of the received sensing request;
an angle of arrival of the sensing request;
an angle of departure of the sensing request; and
a time of flight of the sensing request.

3. The method of claim 2, further comprising configuring the information element to include, in a designated field thereof, a type of the parameter.

4. The method of claim 1, further comprising configuring the information element to include, in one or more designated fields thereof, one or more of:
an indication of a transmit antenna which transmitted a signal associated with the parameter;
an indication of a receive antenna which received the signal associated with the parameter; and
an indication of a subcarrier over which the signal associated with the parameter was transmitted.

5. The method of claim 1 further comprising configuring the sensing response to include a plurality of parameters of the received sensing request, the plurality of parameters including the parameter.

6. A communications device comprising:
a processor coupled to a network interface and a computer readable storage medium, the storage medium storing instructions when executed by the processor, cause the communications device to:
receive over a network interface, a sensing request transmitted by a sensing initiator;
measure the received sensing request and determining a parameter of the received sensing request;
send over the network interface, an action frame to the sensing initiator, the action frame including a category indicative that the action frame contains a sensing response, the sensing response including the parameter in an information element of the action frame.

7. The communications device of claim 6 wherein the parameter is indicative of one of:
an amplitude difference between the received sensing request and the sensing request transmitted by the sensing initiator;
a phase difference between the received sensing request and the sensing request transmitted by the sensing initiator;
an amplitude of the received sensing request;
a phase of the received sensing request;
an angle of arrival of the sensing request;
an angle of departure of the sensing request; and
a time of flight of the sensing request.

8. The communications device of claim 7, further configured to configure the information element to include, in a designated field thereof, a type of the parameter.

9. The communications device of claim 6, further configured to configure the information element to include, in one or more designated fields thereof, one or more of:
an indication of a transmit antenna which transmitted a signal associated with the parameter;
an indication of a receive antenna which received the signal associated with the parameter; and
an indication of a subcarrier over which the signal associated with the parameter was transmitted.

10. The communications device of claim 6, further configured to configure the sensing response to include a plurality of parameters of the received sensing request, the plurality of parameters including the parameter.

11. A computer-readable storage medium having stored thereon a computer program which, when executed by a communications device, causes the communications device to perform a method comprising:
forming an action frame comprising;
an action frame header portion;
a sensing measurement action; and
a sensing measurement information element comprising:
an element ID;
a measurement type;
a parameter of a received sensing request measured by the communications device; and
sending the action frame to a sensing initiator of the sensing request.

12. The computer-readable storage medium of claim 11 wherein the parameter comprises one of:
an amplitude difference between the received sensing request and the sensing request transmitted by the sensing initiator;
a phase difference between the received sensing request and the sensing request transmitted by the sensing initiator;
an amplitude of the received sensing request;
a phase of the received sensing request;
an angle of arrival of the sensing request;
an angle of departure of the sensing request; and
a time of flight of the sensing request.

13. The computer-readable storage medium of claim 11 wherein the information element is further indicative of one or more of:
a Tx port antenna index;
an Rx antenna port index and a subcarrier index.

14. The computer-readable storage medium of claim 11 wherein the information element further includes a plurality of parameters of the received sensing request, the plurality of parameters including the parameter.
